(19) United States
(12) Patent Application Publication
(10) Pub. No.: US 2026/0239243 A1
(43) Pub. Date: Aug. 13, 2026

(54) RECEPTION DEVICE AND METHOD FOR CONTROLLING RECEPTION DEVICE

(71) Applicants: SONY SEMICONDUCTOR SOLUTIONS CORPORATION, KANAGAWA (JP); SONY GROUP CORPORATION, TOKYO (JP)

(72) Inventors: KATSUMI TAKAOKA, KANAGAWA (JP); YUKEN GOTO, KANAGAWA (JP); KATSUYUKI TANAKA, KANAGAWA (JP); SHINGO KAWASHIMA, TOKYO (JP)

(21) Appl. No.: 19/154,116

(22) PCT Filed: Dec. 26, 2023
(86) PCT No.: PCT/JP2023/046622

§ 371 Date: Aug. 6, 2025

(30) Foreign Application Priority Data
Feb. 20, 2023 (JP) 2023-024171

(51) Int. Cl. H04W 56/00; H04W 52/02; H04W 64/00; H04W 84/06

(52) U.S. Cl. CPC H04W 56/0015; H04W 52/028; H04W 64/00; H04W 84/06

(57) ABSTRACT

In a reception device using a global navigation satellite system (GNSS), both shortening of a time period until time correction and improvement of time accuracy are achieved. A reception device includes a message extraction unit, a detection unit, and a time correction unit. In the reception device, the message extraction unit extracts a message including a transmission time from a satellite signal. Furthermore, in the reception device, the detection unit detects a reception timing of a beacon signal from a ground station. Moreover, the time correction unit corrects a current time on the basis of the reception timing and the transmission time.

### TECHNICAL FIELD

The present technology relates to a reception device.

Specifically, the present technology relates to a reception device that receives a signal from a positioning satellite, and a method for controlling a reception device.

### BACKGROUND ART

In related art, a global navigation satellite system (GNSS) represented by a global positioning system (GPS) in the United States has been widely used in various devices for the purpose of acquiring a current position and time. For example, there has been proposed a reception device that calculates a GPS time, retains the GPS time before transitioning to a power saving mode, and corrects a time of a real-time clock by the GPS time when the reception device returns from the power saving mode (see, for example, Patent Document 1.).

### CITATION LIST

### Patent Document

Patent Document 1: Japanese Patent Application Laid-Open No. 2005-3430

### SUMMARY OF THE INVENTION

### Problems to be Solved by the Invention

In the above-described related art, when the reception device returns from the power saving mode, it is possible to correct a time with relatively high accuracy in a short time period by using the retained GPS time and RTC clock. This shortens a time period until next positioning and improves reception sensitivity. However, since the accuracy of a generally used RTC clock is not so high, the accuracy of the time to be corrected when the reception device returns from the power saving mode is not sufficiently high. Furthermore, in the above-described reception device, in a cold start in a state where there is no valid ephemeris data, it takes a time period of 30 seconds or more to obtain a highly accurate time. When time of week (TOW) is used as it is, the time can be corrected within 6 seconds at the shortest, but in this case, the time accuracy is considerably lower than the time obtained by the GNSS calculation. As described above, in the reception device described above, it is difficult to achieve both the time accuracy at the time of returning to the power saving mode, the shortening of the time period until the time correction at the cold start, and the improvement of the time accuracy.

The present technology has been made in view of such a situation, and an object of the present technology is to achieve both shortening of a time period until time correction and improvement of time accuracy in a reception device using a GNSS.

### Solutions to Problems

The present technology has been made to solve the above-described problems, and a first aspect thereof is a reception device including a message extraction unit that extracts a message including a transmission time from a satellite signal, a detection unit that detects a reception timing of a beacon signal from a ground station, and a time correction unit that corrects a current time on a basis of the reception timing and the transmission time, and a control method thereof. Therefore, an effect that time accuracy is improved and a time period until the time correction is shortened is obtained.

Furthermore, in the first aspect, the time correction unit may include a time setting unit that corrects the current time on a basis of a difference between the current time corresponding to the reception timing closest to the transmission time and the transmission time. Therefore, an effect that an error of the current time is corrected is obtained.

Furthermore, in the first aspect, the reception device may further include a control unit that operates the message extraction unit, the detection unit, and the time setting unit in a case where the reception device transitions to the normal mode from a power saving mode having lower power consumption than a normal mode and stops the message extraction unit, the detection unit, and the time setting unit in a case where the reception device transitions to the power saving mode, and the time correction unit may further include a time restoration unit that corrects the current time on a basis of the reception timing in a case where the reception device transitions from the power saving mode to the normal mode. Therefore, an effect that power consumption decreases is obtained.

Furthermore, in the first aspect, the time restoration unit may estimate an error of the current time from a duration of the power saving mode, and correct the current time in a case where the error does not exceed half of a transmission interval of the beacon signal. Therefore, an effect that time accuracy at the time of returning is improved is obtained.

Furthermore, in the first aspect, the reception device may further include a first calculation unit that calculates a reception time of the satellite signal, and the time correction unit may further include a first synchronization unit that corrects the current time on a basis of the reception time of the satellite signal. Therefore, an effect that time accuracy is improved is obtained.

Furthermore, in the first aspect, the reception device may further include a second calculation unit that calculates a reception time of the beacon signal, and the time correction unit may further include a second synchronization unit that corrects the current time on a basis of the reception time of the beacon signal. Therefore, an effect that time accuracy is improved is obtained.

Furthermore, in the first aspect, the time correction unit may further include a third synchronization unit that corrects the current time on a basis of the reception timing. Therefore, an effect that highly accurate time is maintained even during the power saving mode is obtained.

Furthermore, in the first aspect, the reception device may further include a real-time clock that generates a predetermined clock signal, and a counter that counts a count value in synchronization with the clock signal and retains the count value as the current time. Therefore, an effect that the time is maintained even though the power supply is being cut off is obtained.

Furthermore, in the first aspect, the reception device may further include an oscillator that generates a high-frequency signal having a frequency higher than a frequency of the clock signal, and the time correction unit may further include a current time calibration unit that calibrates the current time on a basis of the high-frequency signal and the clock signal. Therefore, an effect that time accuracy is improved.

Furthermore, in the first aspect, the reception device may further include a control unit that stops the oscillator in a case where the reception device transitions from the normal mode to the power saving mode in which power consumption is lower than in the normal mode.

Furthermore, in the first aspect, the message extraction unit may acquire time of week (TOW) as the transmission time. Therefor, an effect that a time period until time correction is shortened is obtained.

### BRIEF DESCRIPTION OF DRAWINGS

FIG. 1 is a diagram illustrating a configuration example of a communication system according to a first embodiment of the present technology.

FIG. 2 is a block diagram illustrating a configuration example of a reception device according to the first embodiment of the present technology.

FIG. 3 is a diagram illustrating an example of a state of a reception device during a sleep mode according to the first embodiment of the present technology.

FIG. 4 is a block diagram illustrating a configuration example of a time correction unit according to the first embodiment of the present technology.

FIG. 5 is a block diagram illustrating a configuration example of a time restoration unit according to the first embodiment of the present technology.

FIG. 6 is a block diagram illustrating a configuration example of a time setting unit according to the first embodiment of the present technology.

FIG. 7 is a diagram illustrating an example of a data structure of a navigation message in a satellite signal according to the first embodiment of the present technology.

FIG. 8 is a diagram illustrating an example of a beacon signal transmission method according to the first embodiment of the present technology.

FIG. 9 is a diagram for describing uncertainty of a transmission time according to the first embodiment of the present technology.

FIG. 10 is a diagram for describing uncertainty of a reception timing of a beacon signal according to the first embodiment of the present technology.

FIG. 11 is a timing chart illustrating an example of an operation of the reception device at the start of positioning according to the first embodiment of the present technology.

FIG. 12 is a timing chart illustrating an example of an operation of the reception device before and after returning according to the first embodiment of the present technology.

FIG. 13 is a flowchart illustrating an example of the operation of the reception device at the start of positioning according to the first embodiment of the present technology.

FIG. 14 is a flowchart illustrating an example of the operation of the reception device at the time of returning according to the first embodiment of the present technology.

FIG. 15 is a block diagram illustrating a configuration example of a reception device according to a second embodiment of the present technology.

FIG. 16 is a block diagram illustrating a configuration example of a time correction unit according to the second embodiment of the present technology.

FIG. 17 is a block diagram illustrating a configuration example of a reception device according to a third embodiment of the present technology.

FIG. 18 is a block diagram illustrating a configuration example of a time correction unit according to the third embodiment of the present technology.

FIG. 19 is a diagram illustrating an example of a state of a reception device during a sleep mode according to a fourth embodiment of the present technology.

FIG. 20 is a diagram illustrating an example of a state of a time correction unit during the sleep mode according to the fourth embodiment of the present technology.

FIG. 21 is a block diagram illustrating a configuration example of an MBS synchronization unit according to the fourth embodiment of the present technology.

FIG. 22 is a timing chart illustrating an example of an operation of the reception device before and after returning according to the fourth embodiment of the present technology.

### MODE FOR CARRYING OUT THE INVENTION

Modes for carrying out the present technology (hereinafter, referred to as embodiments) will be described below. The description will be given in the following order.
1. First Embodiment (example of time correction on basis of reception timing and transmission time)
2. Second Embodiment (example in which time is corrected on basis of reception timing and transmission time and time is not corrected by GNSS time)
3. Third Embodiment (example in which time is corrected on basis of reception timing and transmission time and time is corrected by MBS time)
4. Fourth Embodiment (example in which time is corrected on basis of reception timing and transmission time and time is corrected even during sleep)

### 1. First Embodiment

### [Configuration Example of Communication System]

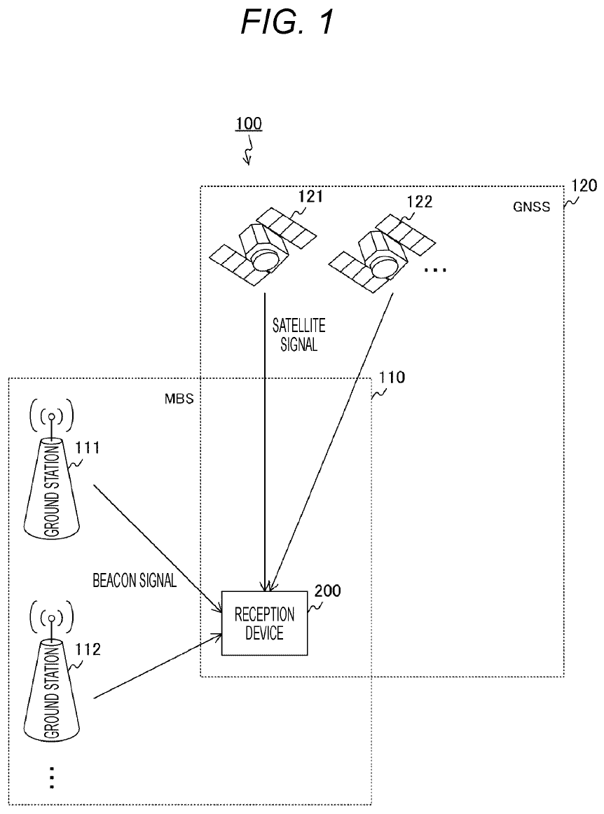

FIG. 1 is a diagram illustrating a configuration example of a communication system 100 according to an embodiment of the present technology. The communication system 100 includes a metropolitan beacon system (MBS) 110 and a GNSS 120. The MBS 110 includes a plurality of ground stations, such as ground stations 111 and 112, and a reception device 200. For example, a base station, a locator, or the like is used as the ground station. The GNSS 120 includes a plurality of positioning satellites, such as positioning satellites 121 and 122, and the reception device 200.

In the MBS 110, each of the ground stations periodically transmits a beacon signal. The reception device 200 can receive these beacon signals, and can acquire positional information and time by calculation similar to the GNSS when the beacon signals are received from four or more ground stations. Note that, the beacon signal received by the reception device 200 is not limited to that of the MBS 110 as long as a transmission interval is known.

For example, GPS is used as the GNSS 120. In the GNSS 120, each of the positioning satellites transmits a satellite signal (such as an LIC/A signal and an LIC signal). The reception device 200 can receive these positioning signals, and can acquire positional information and time by calculation when the Satellite signals are received from four or more positioning satellites. Note that, the GNSS to be used is not limited to the GPS, and may be a quasi-zenith satellite system (QZSS), Galileo, Or the like.

The reception device 200 receives the satellite signal from the positioning satellite and the beacon signal from the ground station. Furthermore, the reception device 200 is a small device that can be carried by a user or mounted on a mobile body. For example, examples of the reception device 200 include a notebook computer, a smartphone, a wristwatch, and an in-vehicle device having a positioning function.

### [Configuration Example of Reception Device]

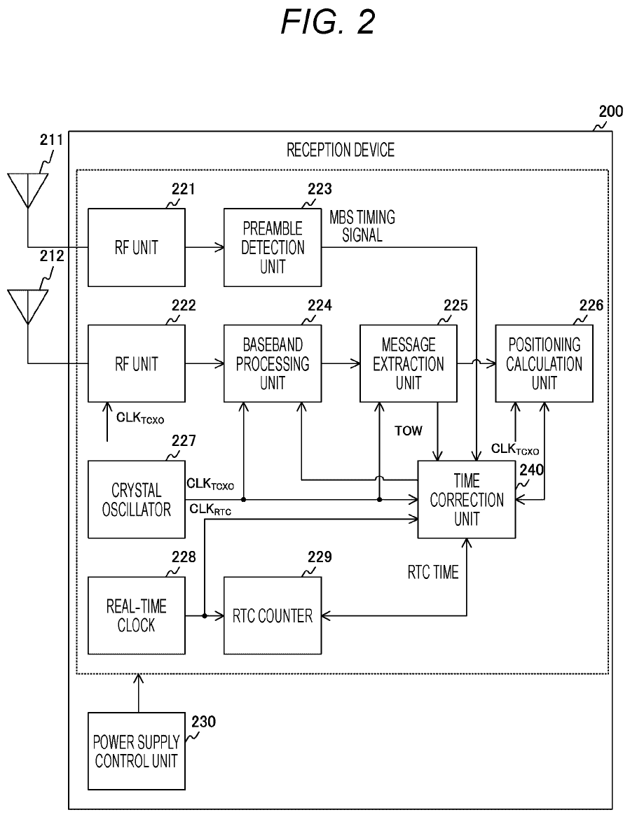

FIG. 2 is a block diagram illustrating a configuration example of the reception device 200 according to a first embodiment of the present technology. The reception device 200 includes antennas 211 and 212, radio frequency (RF) units 221 and 222, a preamble detection unit 223, a baseband processing unit 224, a message extraction unit 225, and a positioning calculation unit 226. Furthermore, the reception device 200 includes a crystal oscillator 227, a real-time clock 228, a real-time clock (RTC) counter 229, a power supply control unit 230, and a time correction unit 240.

The antenna 211 receives the beacon signal by converting an electromagnetic wave from the ground station in the MBS 110 into an electric signal. The antenna 211 supplies, as an RF signal, the received signal to the RF unit 221.

The RF unit 221 performs amplification, frequency conversion, and analog to digital (AD) conversion on the RF signal from the antenna 211. The RF unit 221 supplies the converted signal as a baseband signal to the preamble detection unit 223.

The preamble detection unit 223 decodes the baseband signal and detects a preamble. Here, in the MBS 110, the beacon signals are transmitted at regular intervals, and a preamble, a pilot signal, a pseudo random noise (PRN) code, and the like are stored in an individual beacon signal. The preamble detection unit 223 generates an MBS timing signal indicating a detection timing (in other words, a reception timing of the beacon signal) of the preamble and supplies the MBS timing signal to the time correction unit 240. Since the beacon signal is periodically transmitted, the preamble is also detected periodically. Thus, a cycle signal having a transmission interval of the beacon signal as a cycle is supplied as the MBS timing signal.

Note that, the preamble detection unit 223 is an example of a detection unit described in the claims.

The antenna 212 receives the satellite signal by converting an electromagnetic wave from the positioning satellite in the GNSS 120 into an electric signal. The antenna 212 supplies, as an RF signal, the received signal to the RF unit 222.

The RF unit 222 performs amplification, frequency conversion, and AD conversion on the RF signal from the antenna 212. The RF unit 222 supplies the converted signal as a baseband signal to the baseband processing unit 224.

The baseband processing unit 224 supplements and tracks a predetermined number of positioning satellites to achieve timing synchronization. The baseband processing unit 224 supplies, as a demodulation signal, a signal of which a timing is synchronized to the message extraction unit 225.

The message extraction unit 225 decodes the demodulated signal and extracts a navigation message. Here, the navigation message in the LIC/A signal is transmitted every 30 seconds in a unit called a frame. Each of frames includes five subframes having the same size. A transmission interval of individual subframes is 6 seconds. Furthermore, TOW and Week Number (WN) are stored in each of the subframes. A storage location of these pieces of information will be described later.

The TOW is a cumulative second within a week starting from 00:00:00 on Sunday. The WN is a value obtained by continuing the accumulation of the week without resetting the count from a predetermined date (such as Jan. 6, 1980) as a starting point over the years. The transmission time in the year, month, day, minute, and second format at which the positioning satellite transmits the satellite signal is represented by the TOW and the WN. In a case where the correct year, month, and date are set in the reception device 200, since it is not necessary to obtain the year, month, and date from the WN, the transmission time can be obtained only from the TOW. Hereinafter, it is assumed that the year, month, and date set in the reception device 200 are accurate.

The message extraction unit 225 supplies the TOW to the time correction unit 240 and supplies the navigation message to the positioning calculation unit 226. Note that, in a case where the year, month, and date set in the reception device 200 are inaccurate, such as in an initial state, the message extraction unit 225 can transmit the WN in addition to the TOW to the time correction unit 240.

The positioning calculation unit 226 calculates positional information and a reception time of the satellite signal by using the navigation message from each of four or more positioning satellites. The positioning calculation unit 226 supplies, to the time correction unit 240, the reception time as a receiver time managed by the reception device 200 (receiver).

Note that, the reception device 200 can also externally output the positional information.

The crystal oscillator 227 generates a clock signal CLK_{TCXO} having a higher frequency than a signal generated by the real-time clock 228. The crystal oscillator 227 supplies the clock signal CLK_{TCXO} to each circuit such as the RF unit 222 and the time correction unit 240. In the drawing, only transmission paths to the RF unit 222, the baseband processing unit 224, the message extraction unit 225, and the time correction unit 240 are illustrated for the sake of convenience in description, and the remaining transmission paths are omitted. Furthermore, the clock signal CLK_{TCXO} is not supplied to the real-time clock 228.

Note that, the crystal oscillator 227 is an example of an oscillator described in the claims, and the clock signal CLK_{TCXO} is an example of a high frequency signal described in the claims.

The real-time clock 228 operates even after the power supply of the reception device 200 is cut off, and generates a predetermined clock signal CLK_{RTC}. An oscillation circuit and a battery (not illustrated) are provided in the real-time clock 228. The real-time clock 228 supplies the clock signal CLK_{RTC} to the RTC counter 229 and the time correction unit 240.

Here, a frequency of the clock signal CLK_{RTC} is, for example, 32768 hertz (Hz). Furthermore, the frequency of the clock signal CLK_{TCXO} is higher than the frequency of the clock signal CLK_{RTC}, and is, for example, a frequency in units of megahertz (MHz). A frequency of the crystal oscillator 227 is higher than that of the real-time clock 228, but power consumption is accordingly large. Thus, from the viewpoint of power saving, the crystal oscillator 227 is stopped by the power supply control unit 230 at the time of transitioning to a sleep mode as described later.

The RTC counter 229 counts a count value in synchronization with the clock signal CLK_{RTC} and retains the count value as an RTC time. The RTC time indicates a current time set in the reception device 200.

Here, an error occurs in the RTC time due to product variation, temperature characteristics, aging, and the like of the circuit in the real-time clock 228. On the other hand, the accuracy of the time obtained by positioning calculation is generally higher than that of the crystal oscillator 227 or the real-time clock 228.

The time correction unit 240 accurately corrects and updates the receiver time on the basis of the clock signal CLK_{TCXO}, the clock signal CLK_{RTC}, the TOW, the MBS timing signal, the RTC time, and the positioning calculation. Furthermore, the receiver time is used for capturing a satellite in the baseband processing unit 224 and the positioning calculation unit 226. Note that, the receiver time is an example of a current time described in the claims. Details of a correction method will be described later.

The power supply control unit 230 controls the power supply of each of the circuits in the reception device 200. It is assumed that either a normal mode or a sleep mode lower in power consumption than the normal mode is set to the reception device 200.

In the normal mode, the power supply control unit 230 supplies power of to each circuit in the reception device 200 to operate. However, it is not necessary to operate all the circuits. According to the positioning calculation, a highly accurate receiver time having an error of about several tens of nanoseconds can be obtained, but power consumption of the positioning calculation is higher than that of the crystal oscillator 227 and the real-time clock 228, Thus, from the viewpoint of power saving, the positioning calculation is executed at a predetermined timing or at regular intervals. In a period in which positioning is not performed, the power supply control unit 230 stops the positioning calculation unit 226.

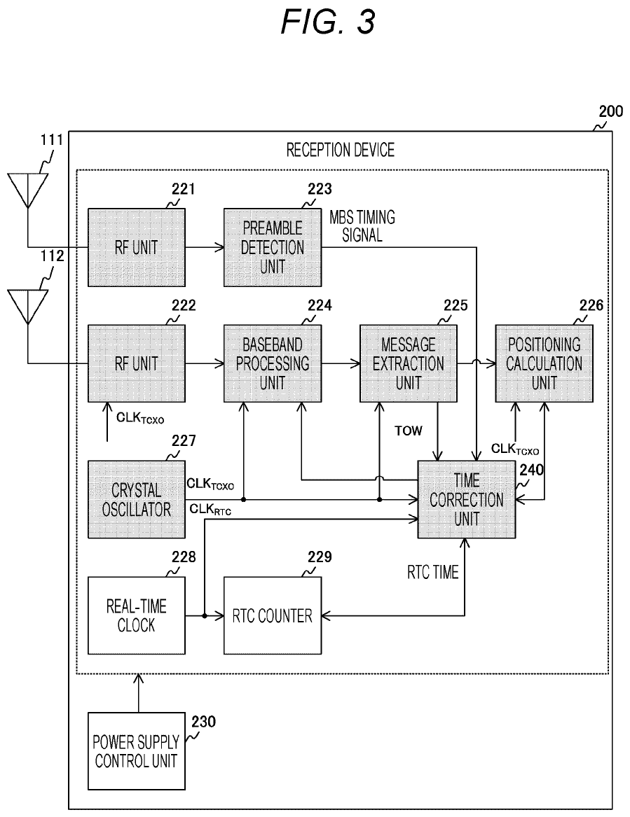

On the other hand, as illustrated in FIG. 3, in the sleep mode, the reception device 200 stops circuits other than the real-time clock 228 and the RTC counter 229. In the drawing, a gray portion indicates a circuit in which the power supply is cut off and stopped.

Note that, although the power supply control unit 230 turns on or off the power supply, the present technology is not limited to this configuration, and the circuit can be stopped by an enable signal while the power supply is turned on.

Note that, the sleep mode is an example of a power saving mode described in the claims. Furthermore, the power supply control unit 230 is an example of a control unit described in the claims.

### [Configuration Example of Time Correction Unit]

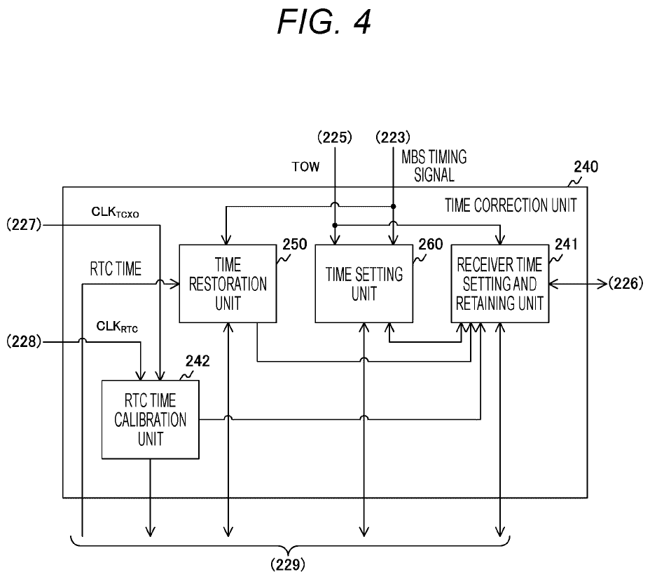

FIG. 4 is a block diagram illustrating a configuration example of the time correction unit 240 according to the first embodiment of the present technology. The time correction unit 240 includes an RTC time calibration unit 242, a time restoration unit 250, a time setting unit 260, and a receiver time setting and retaining unit 241.

The RTC time calibration unit 242 calibrates the RTC time on the basis of the clock signal CLK_{RTC} and the clock signal CLK_{TCXO} in the normal mode. The RTC time calibration unit 242 counts within the cycle of the clock signal CLK_{RTC} in synchronization with the clock signal CLK_{TCXO} having a higher frequency than the clock signal CLK_{RTC}, and measures the frequency of the clock signal CLK_{RTC} from the count value. The RTC time calibration unit 242 calculates, as an error, a shift of the measured value from a reference value, and calibrates the RTC time on the basis of the error. The calibration of the RTC time is executed at a predetermined timing such as at the time of activation. Alternatively, the RTC time is calibrated periodically.

The time restoration unit 250 corrects the RTC time on the basis of the MBS timing signal when the reception device transitions (in other words, returned) from the sleep mode to the normal mode. Details of the correction method will be described later.

The time setting unit 260 corrects the receiver time on the basis of the TOW (transmission time) and the MBS timing signal in the normal mode. Details of the correction method will be described later. The correction by the time setting unit 260 is executed between the time of activation and the first positioning calculation.

The receiver time setting and retaining unit 241 corrects the receiver time on the basis of the TOW output from the message extraction unit 225 and the output from each of the RTC time calibration unit 242, the time restoration unit 250, the time setting unit 260, and the positioning calculation unit 226. In a case where the time is calculated by the positioning calculation unit 226, the receiver time setting and retaining unit 241 obtains, as an error, a difference between the time and a current receiver time, and corrects the current receiver time on the basis of the error.

Furthermore, assuming that the time obtained from the beacon signal from the MBS 110 is the MBS time, the RTC time and the receiver time are corrected to values close to the MBS time by each of pieces of processing of the time restoration unit 250 and the time setting unit 260. In other words, the RTC time and the like can be synchronized with the MBS time. Furthermore, by the processing of the receiver time setting and retaining unit 241, the current receiver time can be synchronized with the time obtained by the positioning calculation. As described above, the correction of the time by the time restoration unit 250, the time setting unit 260, and the GNSS calculation can also be referred to as “synchronization”. Note that, the receiver time setting and retaining unit 241 is an example of a first synchronization unit described in the claims.

Furthermore, although the time correction unit 240 calibrates the RTC time by using the clock signal CLK_{TCXO}, the time correction unit may not perform this calibration. In this Case, the RTC time calibration unit 242 is unnecessary.

Furthermore, although the time correction unit 240 corrects the RTC time on the basis of the MBS timing signal at the time of returning, this correction may not be performed at the time of returning. In this case, the time restoration unit 250 becomes unnecessary.

### [Configuration Example of Time Restoration Unit]

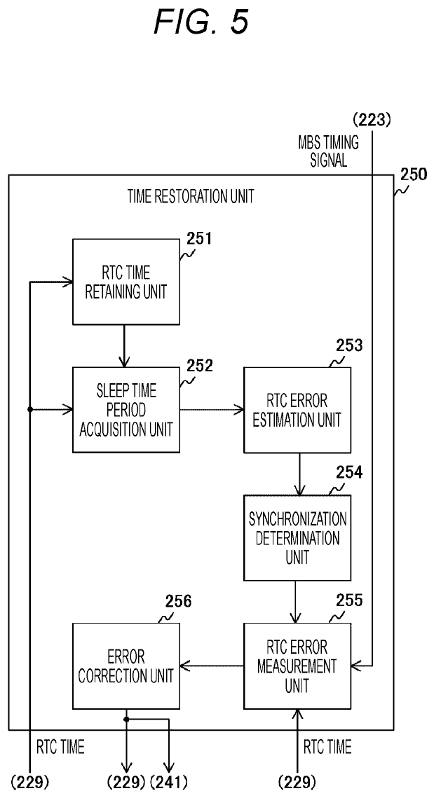

FIG. 5 is a block diagram illustrating a configuration example of the time restoration unit 250 according to the first embodiment of the present technology. The time restoration unit 250 includes an RTC time retaining unit 251, a sleep time period acquisition unit 252, an RTC error estimation unit 253, a synchronization determination unit 254, an RTC error measurement unit 255, and an error correction unit 256.

The RTC time retaining unit 251 retains the RTC time immediately before transitioning to the sleep mode. In a case where the power supply of the RTC time retaining unit 251 is cut off in the sleep mode, for example, a nonvolatile memory is used as the RTC time retaining unit 251.

The sleep time period acquisition unit 252 acquires a time period during which the sleep mode continues as a sleep time period. When the reception device transitions from the sleep mode to the normal mode, the sleep time period acquisition unit 252 acquires, as a return time, the RTC time from the RTC counter 229. Then, the sleep time period acquisition unit 252 calculates, as a sleep time period Ts, a difference between the return time and the time retained in the RTC time retaining unit 251, and supplies the sleep time period Is to the RTC error estimation unit 253.

The RTC error estimation unit 253 estimates an error of the RTC time occurring during the sleep mode. In a case where a deviation of the clock signal CLK_{RTC} is ±5 ppm (parts-per-million), for example, the RTC error estimation unit 253 calculates an error Err which is an estimated value by the following expression and supplies the error Err to the synchronization determination unit 254.

$$Err = \pm 5 \times 1 e - 6 \times Ts$$

In the above expression, the unit of each of the error Err and the sleep time period Ts is, for example, seconds (s).

Note that, the RTC error estimation unit 253 can further acquire a temperature from an external temperature sensor and can estimate an error on the basis of temperature characteristics of the real-time clock 228 and the sleep time period.

The synchronization determination unit 254 determines whether or not the error Err exceeds half of the transmission interval of the beacon signal. For example, in a case where the transmission interval of the beacon signal is 100 milliseconds, it is determined whether or not the error Err exceeds 50 milliseconds, which is the half of the transmission interval. The synchronization determination unit 254 supplies the determination result to the RTC error measurement unit 255.

Here, in a case where the error Err exceeds 50 milliseconds, it is necessary to correct digits (for example, in units of 0.1 seconds or 1 second) higher than 0.01 seconds of the RTC time. However, in the first embodiment, the reception device 200 detects the reception timing of the beacon signal every 0.1 seconds, but does not calculate the MBS time itself. Thus, the reception device 200 cannot know an accurate value of the significant digit, and cannot correct the significant digit.

In a case where the error Err is 50 milliseconds or less (in other words, the error can be corrected), the RIC error measurement unit 255 measures the RIC error on the basis of the MBS timing signal. At the time of measurement, the RIC error measurement unit 255 acquires the RTC time from the RTC counter 229 at the reception timing indicated by the MBS timing signal. Then, in a case where the last 2 digits of a value in milliseconds of the acquired RTC time are 50 milliseconds or less, the RTC error measurement unit 255 obtains the value as the error. In a case where the last 2 digits exceed 50 milliseconds, the RTC error measurement unit 255 obtains, as the error, a value obtained by subtracting 100 from the last 2 digits. For example, in a case where the RTC time is 128 milliseconds, +28 milliseconds of the last 2 digits is measured as the error. In a case where the RTC time is 198 milliseconds, −2 milliseconds obtained by subtracting 100 from 98 is measured as the error.

The RTC error measurement unit 255 supplies the measured error to the error correction unit 256. The error correction unit 256 corrects the RTC time on the basis of the error.

### [Configuration Example of Time Setting Unit]

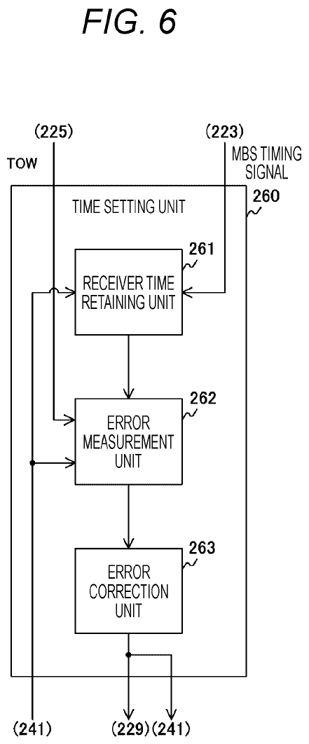

FIG. 6 is a block diagram illustrating a configuration example of the time setting unit 260 according to the first embodiment of the present technology. The time setting unit 260 includes a receiver time retaining unit 261, an error measurement unit 262, and an error correction unit 263.

The receiver time retaining unit 261 retains the receiver time at the reception timing indicated by the MBS timing signal from the preamble detection unit 223. The beacon signal is periodically transmitted, but the receiver time of the receiver time retaining unit 261 is updated to a latest time whenever the beacon signal is transmitted.

The error measurement unit 262 calculates a receiver time at a timing closest to the TOW among reception timings at regular intervals indicated by the MBS timing signal.

Although a propagation time period of the satellite signal from the positioning satellite to the reception device 200 varies, an average propagation time period is ΔTp. Furthermore, a processing delay from the reception of the satellite signal to the acquisition of the TOW by decoding is defined as ΔTd.

First, the error measurement unit 262 acquires, as a T_{DEC}, the receiver time when the TOW is acquired by decoding from the receiver time setting and retaining unit 241. Then, the error measurement unit 262 calculates T_{DEC}−ΔTp−ΔTd as an estimated value of the TOW.

Furthermore, the error measurement unit 262 reads the receiver time of the MBS reception timing, which is the reception timing of the latest MBS timing signal, from the receiver time retaining unit 261. Since the transmission interval of the beacon signal is known, the receiver time of each MBS reception timing before the latest MBS reception timing can be calculated from the read receiver time. The error measurement unit 262 acquires the receiver time at a timing closest to the estimated value of the TOW among the reception timings.

Then, the error measurement unit 262 calculates, as the error, a difference between the acquired receiver time and the TOW and supplies the error to the error correction unit 263. The error correction unit 263 corrects the receiver time on the basis of the error.

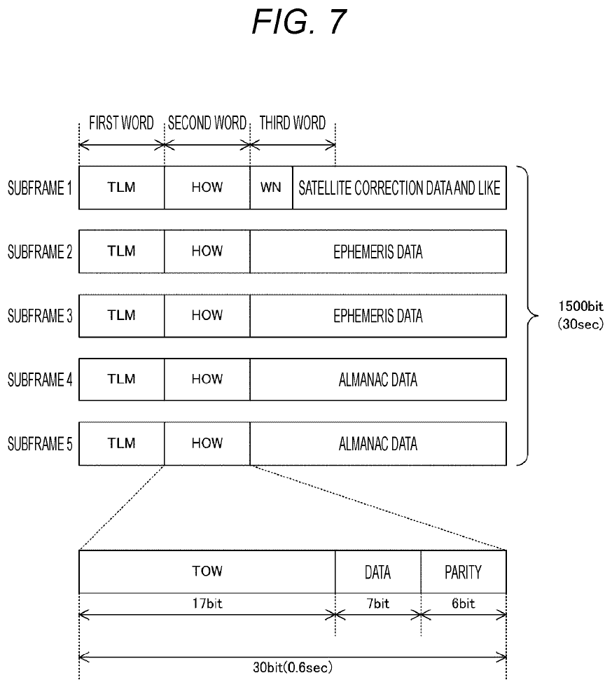

FIG. 7 is a diagram illustrating an example of a data structure of the navigation message in the satellite signal according to the first embodiment of the present technology. As illustrated in the drawing, the navigation message is transmitted in units of 1500-bit frames every 30 seconds. Each of the frames includes five subframes having the same size. A transmission interval of individual subframes is 6 seconds.

Each of the five subframes includes 10 words in units of 30 bits. Telemetry (TLM) data is stored in a first word. Hand over word (HOW) data is stored in a second word, and the TOW is stored in the HOW data. Furthermore, the WN is stored in a third word.

Furthermore, ephemeris data is stored after third words of second and third subframes. Almanac data is stored after third words of fourth and fifth subframes.

Examples of an activation state in the GPS include cold start, warm start, and hot start. The cold start is an activated state where neither valid almanac data nor ephemeris data is acquired by the reception device 200. The warm start is an activated state where valid almanac data is acquired but valid ephemeris data is not acquired. The hot start is an activated state where both valid almanac data and ephemeris data are acquired by the reception device 200.

In general, in the cold start, it takes a time period of about 30 seconds to perform initial positioning and calculation of the receiver time, and in the hot start, it takes a time period of about several seconds to perform initial positioning and calculation of the receiver time.

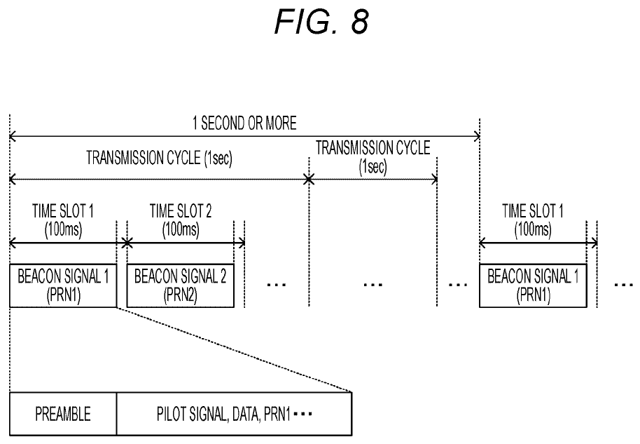

FIG. 8 is a diagram illustrating an example of a beacon signal transmission method according to the first embodiment of the present technology. In the MBS 110, a transmission cycle of 1 second is divided into 10 time slots of 100 milliseconds. The ground station is individually assigned to each of the time slots. PRN is used as identification information of each of the ground stations.

Within a time slot, a corresponding ground station transmits a beacon signal. Each of the beacon signals stores a preamble, a pilot signal, data, PRN, and the like.

For example, a ground station corresponding to PRN1 transmits a beacon signal in a first time slot within a predetermined transmission cycle, and a ground station corresponding to PRN2 transmits a beacon signal in a next time slot.

The transmission of all the ground stations is completed within a predetermined period of one second or more after the first ground station corresponding to the PRN1 transmits the beacon signal, and the control to sequentially transmit the beacon signal from the first ground station is executed every predetermined period.

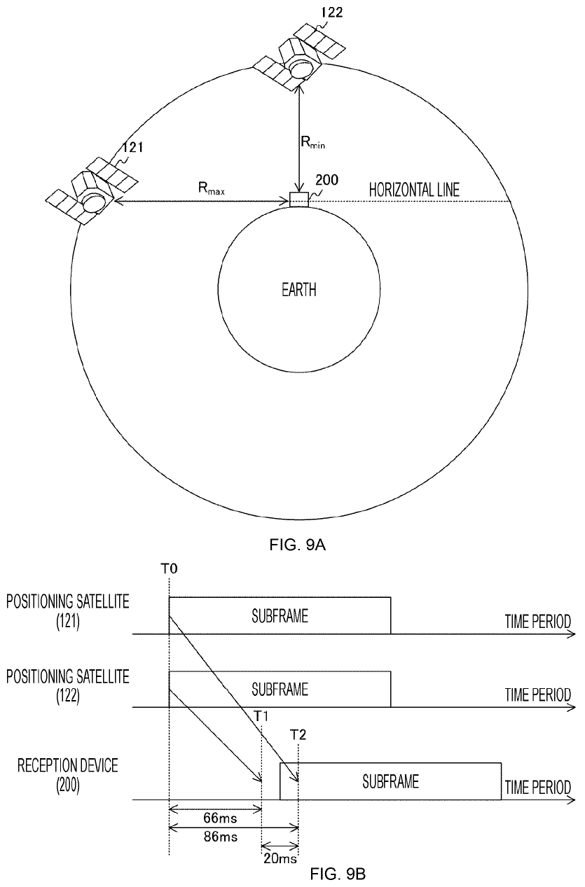

FIG. 9 is a diagram for describing uncertainty of the transmission time according to the first embodiment of the present technology. In the drawing, a is a diagram illustrating an example of distances from the positioning satellites 121 and 122 to the reception device 200. In the drawing, b is a diagram illustrating an example of a propagation time period of a subframe for every positioning satellite.

Since the positioning satellite orbits on a predetermined satellite orbit, the distance from the positioning satellite to the reception device 200 varies depending on a position of the positioning satellite at the time of receiving the subframe. For example, as illustrated in a of the drawing, in a case where the positioning satellite 121 is present in a horizontal line direction as viewed from the reception device 200, the distance to the reception device 200 is maximum Rₘₐₓ. In a case where the positioning satellite 122 is present in a zenith direction, the distance to the reception device 200 is minimum Rₘᵢₙ. Rₘₐₓ is, for example, 25, 593 kilometers (km), and Rₘᵢₙ is, for example, 20,000 kilometers (km).

As illustrated in b of the drawing, in a case where the farthest positioning satellite 121 transmits the subframe at timing T0, the subframe reaches the reception device 200 at timing T1 which is about 86 milliseconds (ms) obtained by dividing 25,593 kilometers (km) by a speed of light. On the other hand, in a case where the closest positioning satellite 122 transmits the subframe at timing T0, the subframe reaches the reception device 200 at timing T2 that is about 66 milliseconds (ms) obtained by dividing 20,000 kilometers (km) by the speed of light.

Thus, the propagation time period of the subframe varies within a range of 20 milliseconds from 66 milliseconds to 86 milliseconds. Assuming that the average propagation time period is 76 milliseconds, the reception device 200 estimates, as a transmission time in the subframe, a time 76 milliseconds before the receiver time at the time of receiving the subframe. However, this estimated time has uncertainty of about 20 milliseconds (ms) due to a variation in propagation time period.

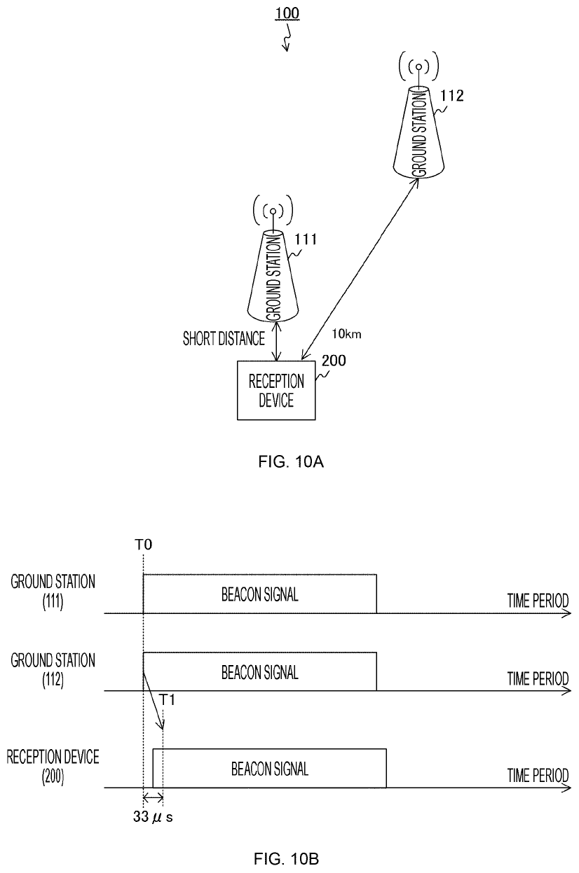

FIG. 10 is a diagram for describing uncertainty of the reception timing of the beacon signal according to the first embodiment of the present technology. In the drawing, a is a diagram illustrating an example of distances from the ground stations 111 and 112 to the reception device 200. In the drawing, b is a diagram illustrating an example of a propagation delay of the beacon signal for every ground station.

Positions of the ground stations 111 and 112 are fixed, but the user may carry and move the reception device 200, or a vehicle on which the reception device 200 is mounted may move. Thus, a distance from the reception device 200 to the ground station varies. As illustrated in a of the drawing, the distance to the ground station 111 is a short distance that can ignore the propagation time period, and the distance to the ground station 112 is about 10 kilometers (km), which is a maximum value of a reachable distance of a radio wave.

As illustrated in b of the drawing, in a case where the farthest ground station 112 transmits the subframe at timing To, the beacon signal reaches the reception device 200 at timing T1 that is about 33 microseconds (μs) obtained by dividing 10 kilometers (km) by the speed of light. On the other hand, in a case where the ground station 111 at a short distance transmits the subframe at timing T0, the beacon signal reaches the reception device 200 at that timing.

Thus, in a case where the reception device 200 detects the reception timing of the beacon signal, the timing has uncertainty of about 33 microseconds (μs).

As described with reference to FIGS. 9 and 10, since the propagation time period of the beacon signal is shorter than the propagation time period of the satellite signal, the time accuracy of the reception timing of the beacon signal is higher than the time accuracy of the estimated value of the transmission time of the satellite signal.

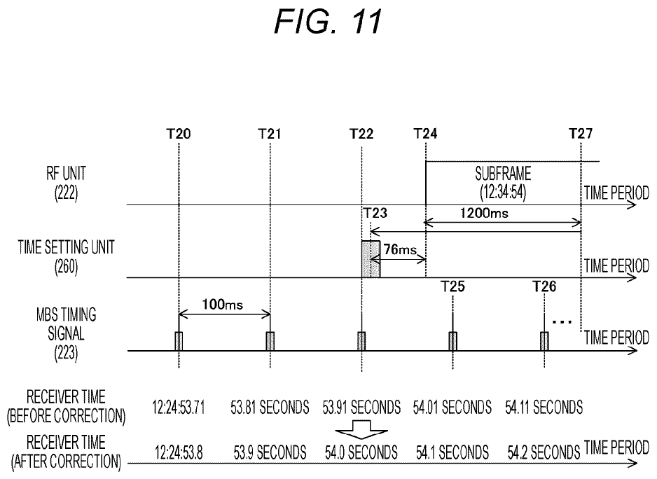

FIG. 11 is a timing chart illustrating an example of an operation of the reception device 200 at the start of positioning according to the first embodiment of the present technology. It is assumed that the reception device 200 starts receiving the satellite signal and the beacon signal immediately before timing T20.

At timings T20, T21, T22, T25, and the like, the preamble detection unit 223 detects the preamble of the beacon signal and generates a pulse of the MBS timing signal at each timing. As described above, each of these reception timings has uncertainty of 33 microseconds (μs). Gray portions before and after the pulse in the drawing indicate uncertain ranges.

It is assumed that the RF unit 222 receives the subframe from the positioning satellite at timing T24 immediately before timing T25. It is assumed that the TOW indicating 12:34:54 is stored in this subframe. As described above, since the subframe of 6 seconds includes 10 words and the TOW is stored in the second word, the processing delay until the TOW is acquired by decoding is 1200 milliseconds or more. In the drawing, it is assumed that the processing delay is the shortest 1200 milliseconds, and the reception device 200 acquires the TOW at timing T27 when 1200 milliseconds elapse from timing T24.

Furthermore, when the average propagation time period is 76 milliseconds, timing T23 76 milliseconds before timing T24 is estimated as the transmission time of the subframe.

The time setting unit 260 calculates an estimated value of the transmission time at timing T23 by calculating 1276 milliseconds before the receiver time at timing T27.

Then, the time setting unit 260 obtains the receiver time at timing T22 closest to timing T23 (transmission time) among the MBS reception timings such as timings T21, T22, and T25. The receiver time at each past timing can be calculated from the receiver time at latest timing T26.

Furthermore, in the drawing, it is assumed that the receiver time is not corrected by the time obtained by the positioning calculation in a period before the first positioning calculation and there is an error in the receiver time. It is assumed that a correct time of timing T22 is 12:34:54, whereas the RTC time at that time is, for example, 12:34:53.91. Note that, it is assumed that the year, month, and date are accurate.

The time setting unit 260 obtains, as an error (−0.09 seconds), a difference between the receiver time (53.91 seconds) at timing T22 and the time (54 seconds) indicated by the TOW. Then, the time setting unit 260 corrects the receiver time on the basis of the error. In this example, +0.09 seconds are added to the receiver time.

When the positioning calculation is performed and the receiver time is corrected by the obtained time, time accuracy can be further improved, but it may take a time period until the first positioning calculation. For example, the cold start requires a time period of about 30 seconds.

In contrast, according to the method for correcting the time by using the TOW in the subframe of 10 words, since the TOW is stored in the second word in the subframe every 6 seconds, the time can be corrected within about 6 seconds at the maximum.

However, when the receiver time is corrected by using a difference between the receiver time at timing T23 and the TOW as the error without using the reception timing of the beacon signal, uncertainty of about 20 milliseconds occurs due to the variation in propagation time period. Gray portions before and after timing T23 in the drawing indicate uncertain ranges.

Therefore, as illustrated in the drawing, the reception device 200 corrects the receiver time on the basis of the reception timing of the beacon signal and the TOW. Since the uncertainty of the reception timing of the beacon signal is 33 microseconds (μs) at the maximum, the use of the reception timing can improve the time accuracy as compared with a case where the reception timing is not used.

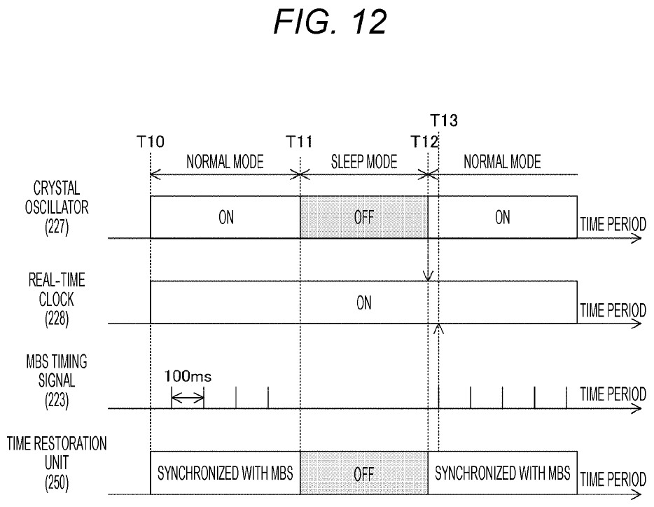

FIG. 12 is a timing chart illustrating an example of an operation of the reception device 200 before and after returning according to the first embodiment of the present technology. It is assumed that the reception device 200 operates in the normal mode within a period from timing T10 to timing T11, transitions to the sleep mode within a period from timing T11 to timing T12, and returns to the normal mode after timing T12.

In the normal mode up to timing T11, the power supply control unit 230 (not illustrated) turns on the power supply of the crystal oscillator 227, the real-time clock 228, and the time restoration unit 250 to operate. The time restoration unit 250 synchronizes the RTC time with the MBS time on the basis of the MBS timing signal.

When the reception device transitions to the sleep mode at timing T11, the power supply control unit 230 turns off and stops the power supply of the crystal oscillator 227 and the time restoration unit 250.

When the reception device returns to the normal mode at timing T12, the power supply control unit 230 turns on the power supply of the crystal oscillator 227 and the time restoration unit 250. Furthermore, the crystal oscillator 227 calibrates the RTC time.

Then, the time restoration unit 250 estimates the error of the RTC time from a duration of the sleep mode. Then, in a case where the error is 50 milliseconds or less, the time restoration unit 250 synchronizes the RTC time with the MBS time at timing T13. Therefore, the highly accurate time before transitioning to the sleep mode is restored. As described above, when the highly accurate time can be restored at the time of returning, the satellite can be supplemented by using symbol boundary information at the hot start. Therefore, time to first fix (TTFF) can be shortened, and sensitivity performance can be improved.

### [Operation Example of Reception Device]

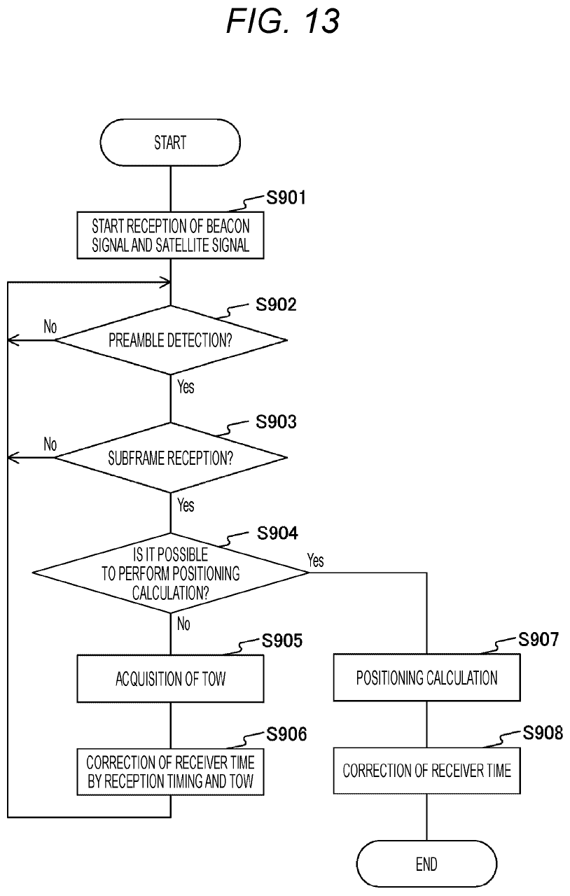

FIG. 13 is a flowchart illustrating an example of an operation of the reception device 200 at the start of positioning according to the first embodiment of the present technology. This operation is started, for example, when a predetermined application for performing the positioning calculation is executed.

The reception device 200 starts receiving the beacon signal and the satellite signal (step S901).

Then, the reception device 200 determines whether or not the preamble of the beacon signal is detected (step S902).

In a case where the preamble is detected (step S902: Yes), the reception device 200 determines whether or not the subframe is received (step S903). In a case where the subframe is received (step S903: Yes), the reception device 200 determines whether or not the positioning calculation can be performed (step S904). In a case where the reception device 200 simultaneously receives subframes from four or more positioning satellites and retains the valid ephemeris data, the positioning calculation can be performed.

In a case where the positioning calculation cannot be performed (step S904: No), the reception device 200 acquires the TOW in the subframe (step S905), and performs the setting of the receiver time by the TOW and the correction by the MBS reception timing (step S906).

In a case where the preamble is not detected (step S902: No), in a case where the subframe is not received (step S903: No), or after step S906, the reception device 200 repeatedly executes step S902 and subsequent steps.

Furthermore, in a case where the positioning calculation can be performed (step S904: Yes), the reception device 200 performs the positioning calculation (step S907), corrects the receiver time by the time obtained by the calculation (step S908), and ends an operation for positioning.

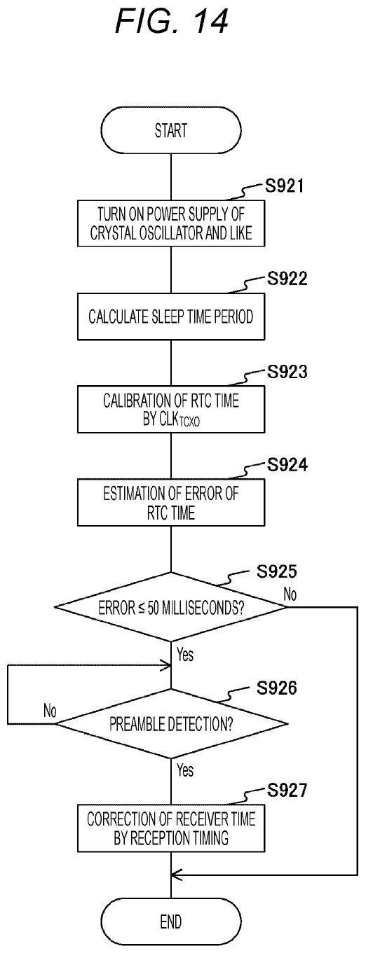

FIG. 14 is a flowchart illustrating an example of an operation of the reception device 200 at the time of returning according to the first embodiment of the present technology. This operation is started when the reception device returns from the sleep mode to the normal mode.

The reception device 200 turns on the power supply of the crystal oscillator 227 and the like (step S921). Then, the reception device 200 calculates a time period during which the sleep mode continues (that is, the sleep time period) (step S922), and calibrates the RTC time by the clock signal CLK_{TCXO} (step S923). Then, the reception device 200 estimates the RTC error generated during the sleep mode from the sleep time period (step S924).

The reception device 200 determines whether or not the estimated error is 50 milliseconds or less (step S925). In a case where the error is 50 milliseconds or less (step S925: Yes), the reception device 200 determines whether or not the preamble of the beacon signal is detected (step S926). In a case where the preamble is not detected (Step S926: No), the reception device 200 repeats step S926.

On the other hand, in a case where the preamble is detected (step S926: Yes), the reception device 200 corrects the RTC time by the reception timing of the beacon signal (step S927).

In a case where the error exceeds 50 milliseconds (step S925: No), or after step S927, the reception device 200 ends the operation for returning time. Thereafter, the reception device 200 executes the processing illustrated in FIG. 13 as necessary.

As described above, according to the first embodiment of the present technology, since the reception device 200 corrects the RTC time on the basis of the reception timing of the beacon signal and the TOW, a time period until the time correction can be shortened as compared with a case where the time by the positioning calculation is used. Furthermore, time accuracy can be improved as compared with a case where the reception timing is not used.

### 2. Second Embodiment

In the first embodiment described above, the reception device 200 acquires the time by the positioning calculation and corrects the receiver time by the time, but the power consumption of the positioning calculation is relatively large. A reception device 200 of a second embodiment is different from that in the first embodiment in that the positioning calculation is not performed.

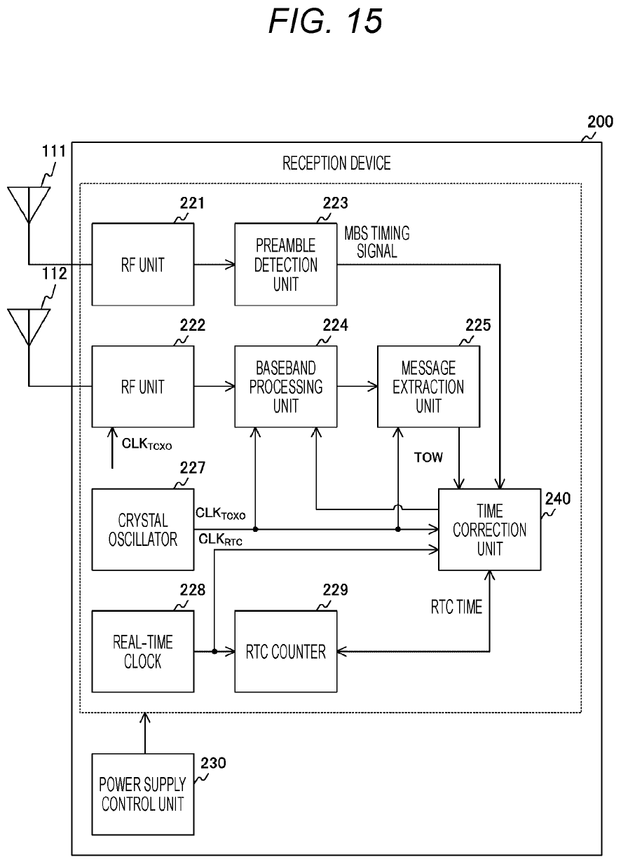

FIG. 15 is a block diagram illustrating a configuration example of the reception device 200 according to the second embodiment of the present technology. The reception device 200 according to the second embodiment is different from that in the first embodiment in that the positioning calculation unit 226 is not disposed.

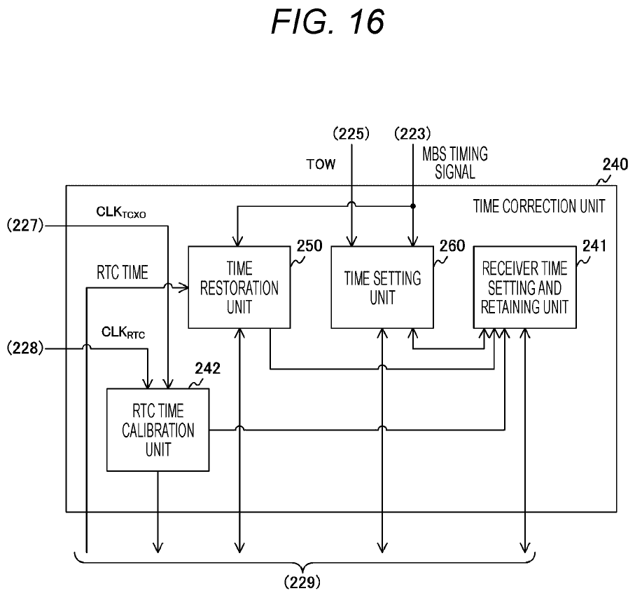

FIG. 16 is a block diagram illustrating a configuration example of the time correction unit 240 according to the second embodiment of the present technology. The receiver time setting and retaining unit 241 according to the second embodiment is different from that in the first embodiment in that the receiver time is not corrected by using a calculation result of the positioning calculation.

As illustrated in FIGS. 15 and 16, since the reception device 200 does not perform the positioning calculation, the power consumption can be reduced as compared with the first embodiment.

Note that, the positioning calculation unit 226 is disposed, and the power supply control unit 230 or the like can stop the circuit within a period in which the positioning calculation is not performed. In this case, the receiver time is corrected by the reception timing and the TOW even in a period in which the positioning calculation is stopped. Therefore, even in a case where the positioning calculation is stopped for a long time period, the reception device 200 can maintain a highly accurate time.

As described above, according to the second embodiment of the present technology, since the reception device 200 does not perform the positioning calculation, the power consumption can be reduced.

### 3. Third Embodiment

In the first embodiment described above, the receiver time is calculated by using the satellite signal, but instead, the receiver time can be calculated by using the beacon signal. A reception device 200 according to a third embodiment is different from that in the first embodiment in that the receiver time is calculated by using the beacon signal.

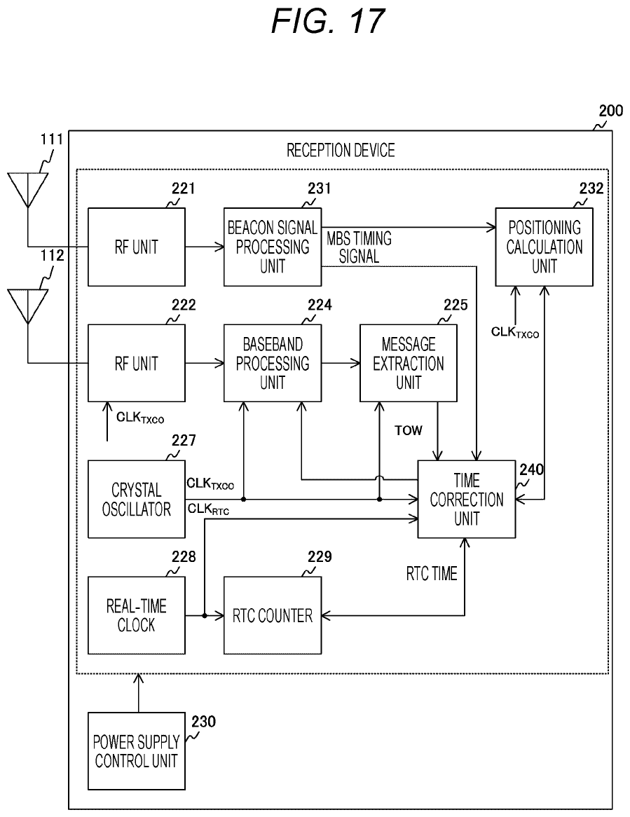

FIG. 17 is a block diagram illustrating a configuration example of the reception device 200 according to the third embodiment of the present technology, The reception device 200 according to the third embodiment is different from that in the first embodiment in that a beacon signal processing unit 231 and a positioning calculation unit 232 are provided instead of the preamble detection unit 223 and the positioning calculation unit 226.

The beacon signal processing unit 231 detects the preamble and extracts data (positional information of the ground station, transmission time, and the like) necessary for the positioning calculation from the beacon signal. The beacon signal processing unit 231 generates the MBS timing signal, supplies the MBS timing signal to the time correction unit 240, and supplies the extracted data to the positioning calculation unit 232.

The positioning calculation unit 232 calculates the positional information of the reception device 200 and the reception time of the beacon signal on the basis of the data obtained from the beacon signal. Positioning can be performed in a case where the beacon signal is received from each of four or more ground stations. The positioning calculation unit 232 supplies, as the MBS time, the calculated reception time to the time correction unit 240.

Furthermore, the message extraction unit 225 of the third embodiment does not acquire the ephemeris data or almanac data.

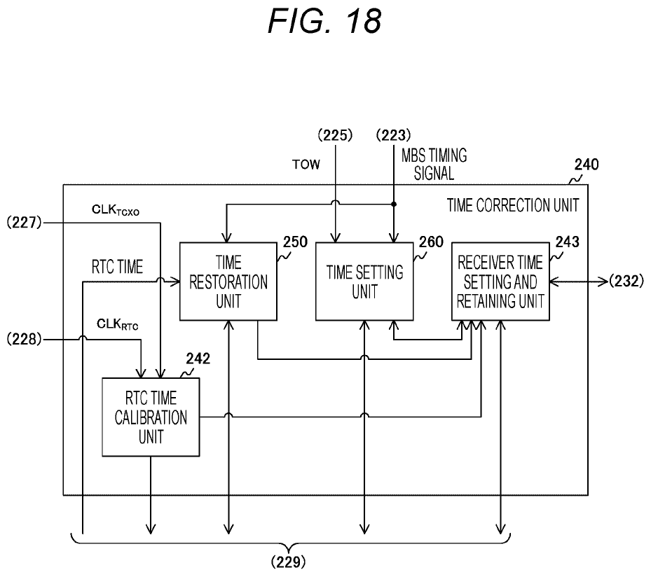

FIG. 18 is a block diagram illustrating a configuration example of the time correction unit 240 according to the third embodiment of the present technology. The time correction unit 240 according to the third embodiment is different from that in the first embodiment in that a receiver time setting and retaining unit 243 is provided instead of the receiver time setting and retaining unit 241.

The receiver time setting and retaining unit 243 corrects the receiver time on the basis of the calculation result of the positioning calculation unit 232. Note that, the receiver time setting and retaining unit 243 is an example of a second synchronization unit described in the claims.

It may be difficult to supplement four or more positioning satellites indoors or the like. However, even in this case, the reception device 200 can the perform positioning calculation by using data in the beacon signal as illustrated in FIGS. 17 and 18.

On the other hand, in the outdoors or the like, there is no ground station in the vicinity, and it may be difficult to receive the beacon signals from four or more ground stations. Thus, for example, the positioning calculation unit 226 using the satellite signal can be further disposed. In this case, for example, the reception device 200 attempts the positioning calculation using the beacon signal and the positioning calculation using the satellite signal in parallel, periodically performs the calculation of the first successful positioning calculation, and stops the other calculation.

As described above, according to the third embodiment of the present technology, since the receiver time is corrected by using the beacon signal, it is possible to realize time accuracy similar to that in a case where the satellite signal is used indoors or the like.

### 4. Fourth Embodiment

In the first embodiment described above, the reception device 200 stops detecting the preamble in the sleep mode, but in this configuration, as the sleep time period becomes longer, there is a possibility that the error of the RTC time becomes larger. A reception device 200 according to a fourth embodiment is different from that in the first embodiment in that the RTC time is corrected on the basis of the MBS timing signal even during the sleep mode.

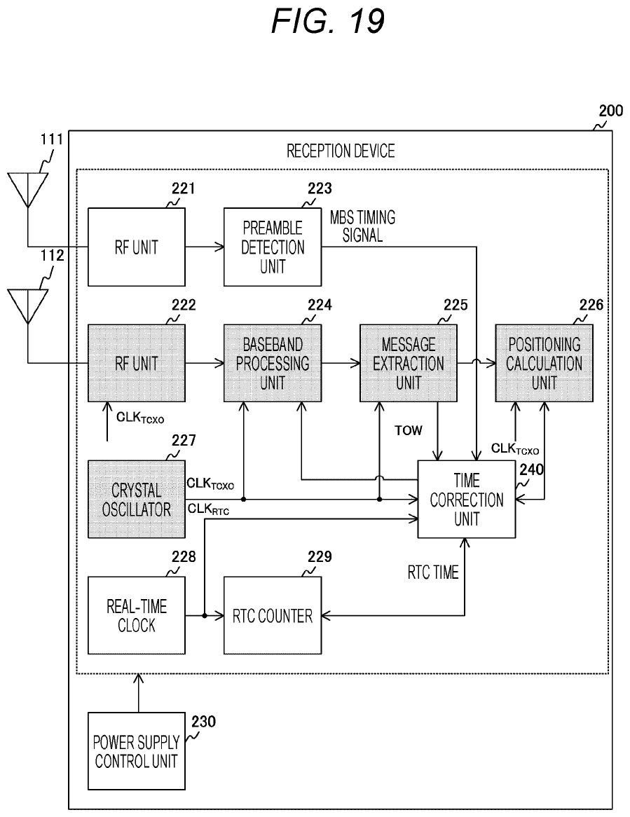

FIG. 19 is a diagram illustrating an example of a state of the reception device 200 during the sleep mode according to the fourth embodiment of the present technology. In the fourth embodiment, the power supply control unit 230 continues the operation without turning off the power supply of the RF unit 221 and the preamble detection unit 223 at the time of transitioning to the sleep mode. Furthermore, the power supply control unit 230 also stops only a part of the function of the time correction unit 240.

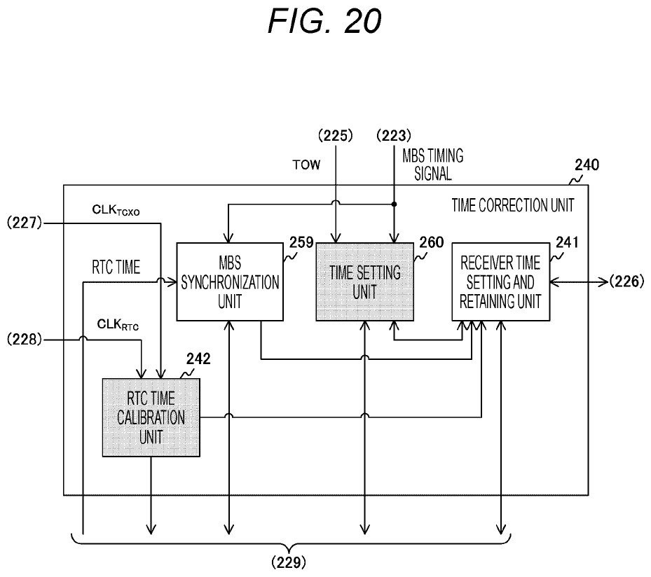

FIG. 20 is a diagram illustrating an example of a state of the time correction unit 240 during the sleep mode according to the fourth embodiment of the present technology. In the fourth embodiment, in the time correction unit 240, an MBS synchronization unit 259 is disposed instead of the time restoration unit 250. Furthermore, the power supply control unit 230 continues the operation without turning off the power supply of the MBS synchronization unit 259 at the time of transitioning to the sleep mode. Circuits other than the MBS synchronization unit 259 are stopped.

The MBS synchronization unit 259 corrects the RTC time on the basis of the MBS timing signal. This correction is periodically performed in each of the normal mode and the sleep mode. Note that, the MBS synchronization unit 259 is an example of a third synchronization unit described in the claims.

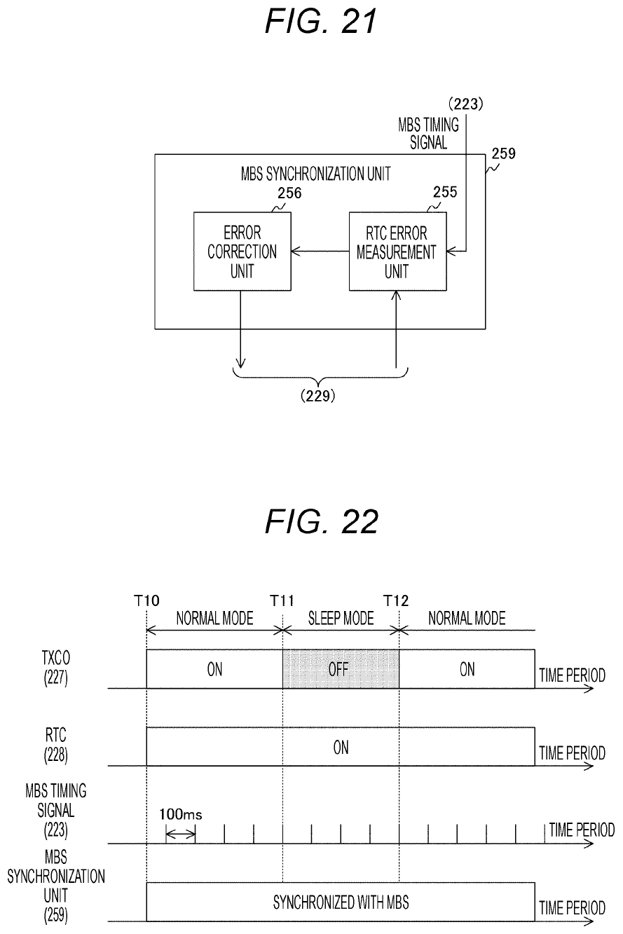

FIG. 21 is a block diagram illustrating a configuration example of the MBS synchronization unit 259 according to the fourth embodiment of the present technology. The MBS synchronization unit 259 includes the RTC error measurement unit 255 and the error correction unit 256. The RTC error measurement unit 255 measures the RTC error on the basis of the MBS timing signal. The error correction unit 256 corrects the RTC time on the basis of the error.

FIG. 22 is a timing chart illustrating an example of an operation of the reception device 200 before and after the returning according to the fourth embodiment of the present technology.

In the normal mode up to timing T11, the power supply control unit 230 (not illustrated) turns on the power supply of the crystal oscillator 227, the real-time clock 228, and the MBS synchronization unit 259 to operate. The MBS synchronization unit 259 synchronizes the RTC time with the MBS time on the basis of the MBS timing signal.

When the reception device transitions to the sleep mode at timing T11, the power supply control unit 230 turns off the power supply of the crystal oscillator 227 and the like to stop. On the other hand, the MBS synchronization unit 259 does not stop even in the sleep mode, and periodically corrects the RIC time during the sleep mode. Therefore, highly accurate time can be maintained even in the sleep mode.

Note that, the second embodiment and the third embodiment can be applied to the fourth embodiment.

As described above, according to the fourth embodiment of the present technology, since the MBS synchronization unit 259 corrects the RTC time on the basis of the MBS timing signal, it is possible to maintain highly accurate time even during the sleep mode.

Note that, the above-described embodiments show examples for embodying the present technology, and the respective matters in the embodiments and the respective matters specifying the invention in the claims have correspondence relationships. Similarly, the respective matters specifying the invention in the claims and the respective matters with the same names in the embodiments of the present technology have correspondence relationships. Note that the present technology is not limited to the embodiments, and can be embodied by applying various kinds of modification to the embodiments without departing from the scope of the present technology.

Furthermore, the procedures described in the above-described embodiments may be considered as a method including a series of procedures and may be considered as a program for allowing a computer to execute the series of procedures and a recording medium which stores the program. As this recording medium, for example, a compact disc (CD), a MiniDisc (MD), a digital versatile disc (DVD), a memory card, a Blu-ray (registered trademark) disc, and the like can be used.

Note that, the effects described in the present specification are merely examples and are not limited, and other effects may also be achieved.

Note that, the present technology can also have the following configurations.
(1) a Reception Device Including:
a message extraction unit that extracts a message including a transmission time from a satellite signal;
a detection unit that detects a reception timing of a beacon signal from a ground station; and
a time correction unit that corrects a current time on a basis of the reception timing and the transmission time.
(2) The reception device according to the above (1),
in which the time correction unit includes a time setting unit that corrects the current time on a basis of a difference between the current time corresponding to the reception timing closest to the transmission time and the transmission time.
(3) The reception device according to the above (2), further including:
a control unit that operates the message extraction unit, the detection unit, and the time setting unit in a case where the reception device transitions to the normal mode from a power saving mode having lower power consumption than a normal mode and stops the message extraction unit, the detection unit, and the time setting unit in a case where the reception device transitions to the power saving mode,
in which the time correction unit further includes a time restoration unit that corrects the current time on a basis of the reception timing in a case where the reception device transitions from the power saving mode to the normal mode.
(4) The reception device according to the above (3),
in which the time restoration unit estimates an error of the current time from a duration of the power saving mode, and corrects the current time in a case where the error does not exceed half of a transmission interval of the beacon signal.
(5) The reception device according to any one of the above (1) to (4), further including:
a first calculation unit that calculates a reception time of the satellite signal,
in which the time correction unit further includes a first synchronization unit that corrects the current time on a basis of the reception time of the satellite signal.
(6) The reception device according to any one of the above (1) to (5), further including:
a second calculation unit that calculates a reception time of the beacon signal,
in which the time correction unit further includes a second synchronization unit that corrects the current time on a basis of the reception time of the beacon signal.
(7) The reception device according to any one of the above (1) to (6),
in which the time correction unit further includes a third synchronization unit that corrects the current time on a basis of the reception timing.
(8) The reception device according to any one of the above (1) to (7), further including:
a real-time clock that generates a predetermined clock signal; and
a counter that counts a count value in synchronization with the clock signal and retains the count value as the current time.
(9) The reception device according to the above (8), further including:
an oscillator that generates a high-frequency signal having a frequency higher than a frequency of the clock signal,
in which the time correction unit further includes a current time calibration unit that calibrates the current time on a basis of the high-frequency signal and the clock signal.
(10) The reception device according to the above (9), further including:
a control unit that stops the oscillator in a case where the reception device transitions from the normal mode to the power saving mode in which power consumption is lower than in the normal mode.
(11) The reception device according to any one of the above (1) to (10),
in which the message extraction unit acquires time of week (TOW) as the transmission time.
(12) A method for controlling a reception device including:
a message extraction step of extracting a message including a transmission time from a satellite signal;
a detection step of detecting a reception timing of a beacon signal from a ground station; and
a time correction step of correcting a current time on a basis of the reception timing and the transmission time.

### REFERENCE SIGNS LIST

100 Communication system
110 MBS
111, 112 Ground station
120 GNSS
121, 122 Positioning satellite
200 Reception device
211, 212 Antenna
221, 222 RF unit
223 Preamble detection unit
224 Baseband processing unit
225 Message extraction unit
226, 232 Positioning calculation unit
227 Crystal oscillator
228 Real-time clock
229 RTC counter
230 Power control unit
231 Beacon signal processing unit
240 Time correction unit
241, 243 Receiver time setting and retaining unit
242 RTC time calibration unit
259 MBS synchronization unit
250 Time restoration unit
251 RTC time retaining unit
252 Sleep time period acquisition unit
253 RTC error estimation unit
254 Synchronization determination unit
255 RTC error measurement unit
256, 263 Error correction unit
260 Time setting unit
261 Receiver error retaining unit
262 Error measurement unit

1. A reception device comprising:
a message extraction unit that extracts a message including a transmission time from a satellite signal;
a detection unit that detects a reception timing of a beacon signal from a ground station; and
a time correction unit that corrects a current time on a basis of the reception timing and the transmission time.

2. The reception device according to claim 1,
wherein the time correction unit includes a time setting unit that corrects the current time on a basis of a difference between the current time corresponding to the reception timing closest to the transmission time and the transmission time.

3. The reception device according to claim 2, further comprising:
a control unit that operates the message extraction unit, the detection unit, and the time setting unit in a case where the reception device transitions to the normal mode from a power saving mode having lower power consumption than a normal mode and stops the message extraction unit, the detection unit, and the time setting unit in a case where the reception device transitions to the power saving mode,
wherein the time correction unit further includes a time restoration unit that corrects the current time on a basis of the reception timing in a case where the reception device transitions from the power saving mode to the normal mode.

4. The reception device according to claim 3,
wherein the time restoration unit estimates an error of the current time from a duration of the power saving mode, and corrects the current time in a case where the error does not exceed half of a transmission interval of the beacon signal.

5. The reception device according to claim 1, further comprising:
a first calculation unit that calculates a reception time of the satellite signal,
wherein the time correction unit further includes a first synchronization unit that corrects the current time on a basis of the reception time of the satellite signal.

6. The reception device according to claim 1, further comprising:
a second calculation unit that calculates a reception time of the beacon signal,
wherein the time correction unit further includes a second synchronization unit that corrects the current time on a basis of the reception time of the beacon signal.

7. The reception device according to claim 1,
wherein the time correction unit further includes a third synchronization unit that corrects the current time on a basis of the reception timing.

8. The reception device according to claim 1, further comprising:
a real-time clock that generates a predetermined clock signal; and
a counter that counts a count value in synchronization with the clock signal and retains the count value as the current time.

9. The reception device according to claim 8, further comprising:
an oscillator that generates a high-frequency signal having a frequency higher than a frequency of the clock signal,
wherein the time correction unit further includes a current time calibration unit that calibrates the current time on a basis of the high-frequency signal and the clock signal.

10. The reception device according to claim 9, further comprising:
a control unit that stops the oscillator in a case where the reception device transitions from the normal mode to the power saving mode in which power consumption is lower than in the normal mode.

11. The reception device according to claim 1,
wherein the message extraction unit acquires time of week (TOW) as the transmission time.

12. A method for controlling a reception device comprising:
a message extraction step of extracting a message including a transmission time from a satellite signal;
a detection step of detecting a reception timing of a beacon signal from a ground station; and
a time correction step of correcting a current time on a basis of the reception timing and the transmission time.
